(19) United States
(12) Patent Application Publication
(10) Pub. No.: US 2011/0298983 A1
(43) Pub. Date: Dec. 8, 2011

(54) Content Processing Apparatus and Content Processing Method

(76) Inventors: Yoko Masuo, Iruma-shi (JP); Noriaki Kawai, Fussa-shi (JP); Rika Kumagai, Oume-shi (JP)

(21) Appl. No.: 13/072,236

(22) Filed: Mar. 25, 2011

(30) Foreign Application Priority Data
Jun. 8, 2010 (JP) 2010-131491

(51) Int. Cl. H04N 9/74

(52) U.S. Cl. 348/584; 348/E09.055

(57) ABSTRACT

According to one embodiment, a content processing apparatus is provided. The content processing apparatus includes: an output module which outputs a content in a viewable format; a real-time term explanation receiving processor which receives an explanation of a term included in the content being output; and a video and term explanation combining module which combines a video of the content with the term explanation. The term explanation for the video is displayed in real-time on the output module.

### CROSS REFERENCE TO RELATED APPLICATION(S)

The application is based upon and claims the benefit of priority from Japanese Patent Application No. 2010-131491 filed on Jun. 8, 2010; the entire content of which are incorporated herein by reference.

### FIELD

Embodiments described herein relate generally to a content processing apparatus and a content processing method for term explanation for a video being output.

### BACKGROUND

There is a content processing apparatus for term explanation for a video being output. In the content processing apparatus, replay is halted as triggered by a user request, a viewing mode is switched over to a term explanation mode, and a term selection screen is displayed.

However, video data of the content and the term explanation cannot be displayed at the same time (in real-time). A large capacity of memory is required to hold a buffer of accumulated content until requested by a user, leading to an increase in cost. Further, the time till receiving term explanation is extended, and thereby the video data and terms of the content can not display at the same time.

### BRIEF DESCRIPTION OF THE DRAWINGS

FIG. 1 is an overall configuration diagram showing a functional system according to an exemplary embodiment;

FIG. 2 is a diagram showing an example of content data according to the exemplary embodiment;

FIG. 3 is a diagram showing an example of a category database according to the exemplary embodiment;

FIG. 4 is a diagram showing an example of a dictionary database according to the exemplary embodiment;

FIG. 5 is a diagram showing an example of display of a usage scene according to the exemplary embodiment;

FIG. 6 is a category determination flow chart according to the exemplary embodiment;

FIG. 7 is a flow chart showing a real-time term explanation display during viewing according to the exemplary embodiment;

FIG. 8 is a flow chart showing processing of a real-time term explanation receiving processor according to the exemplary embodiment;

FIG. 9 is a diagram showing an example of a display candidate term storage module according to the exemplary embodiment;

FIG. 10 is a term explanation selection screen according to the exemplary embodiment; and

FIG. 11 is a schematic block diagram showing a configuration of a television set according to the exemplary embodiment.

### DETAILED DESCRIPTION

In general, according to one exemplary embodiment, a content processing apparatus is provided. The content processing apparatus includes: an output module which outputs a content in a viewable format; a real-time term explanation receiving processor which receives an explanation of a term included in the content being output; and a video and term explanation combining module which combines a video of the content with the term explanation. The term explanation for the video is displayed in real-time on the output module.

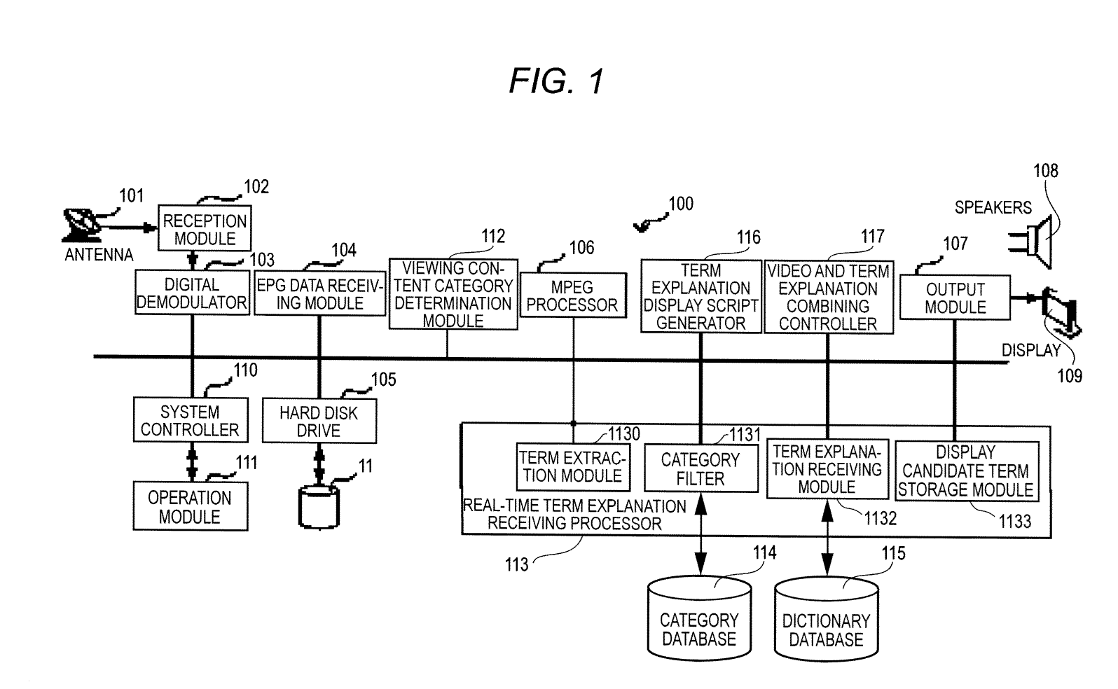

Explanation follows regarding an exemplary embodiment, with reference to FIGS. 1 to 11.

Exemplary embodiments described herein can be applied to digital media replay devices in general, such as a digital television and vehicle navigation system having a video and audio content replay function.

### (Configuration and Operation of a Broadcast Receiving Apparatus)

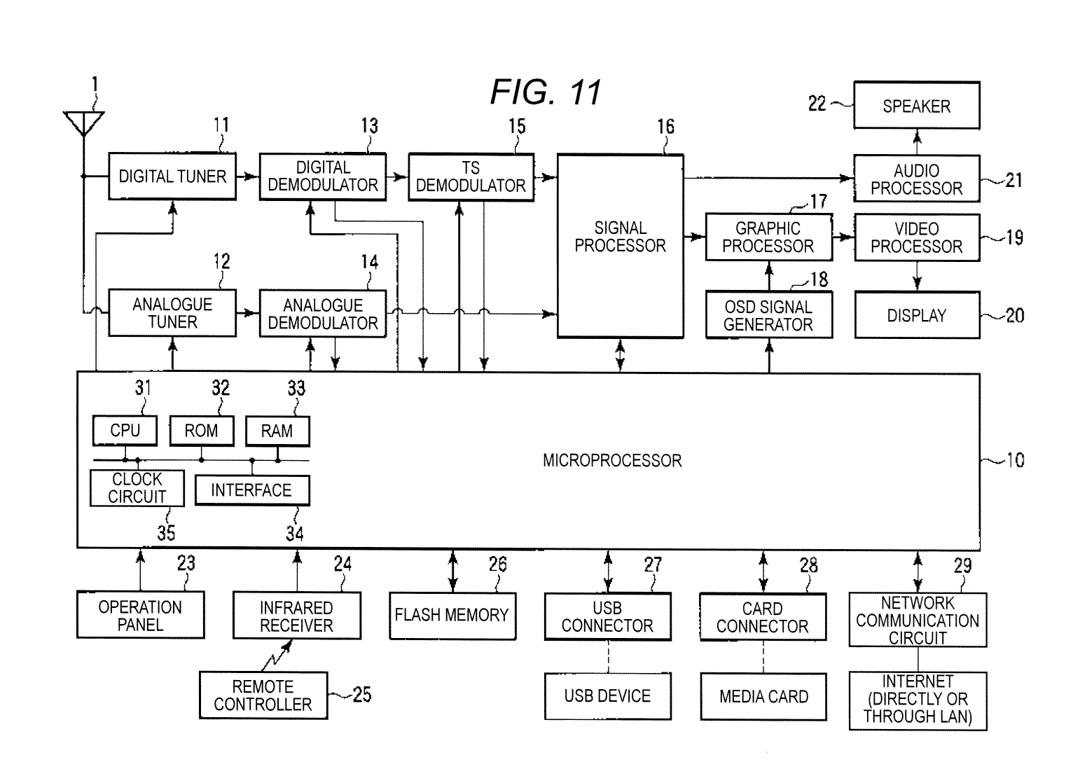

Explanation first follows of a television set of an exemplary embodiment, with reference to FIG. 11.

FIG. 11 is a block diagram showing an example of a configuration of a television set, such as a digital broadcast receiving apparatus, as an exemplary embodiment of a broadcast receiving apparatus for application in the system of FIG. 1, described later.

The television set can receive terrestrial analogue broadcasts, BS, CS and terrestrial digital broadcasts, and includes a microprocessor 10, a digital tuner 11, an analogue tuner 12, a digital demodulator 13, an analogue demodulator 14, and a TS demodulator 15.

BS, CS, and terrestrial digital broadcasts are received by an antenna 1 and the reception signal thereof is supplied to the digital tuner 11. Terrestrial analogue broadcasts are similarly received by the antenna 1 and the reception signal thereof is supplied to the analogue tuner 12. The digital tuner 11 and the analogue tuner 12 use a Phase Locked Loop (PLL) format and, under control of the microprocessor 10, are employed to specify reception parameters, such as respective central frequencies and bandwidths, and select the desired broadcast.

The reception signal of the broadcast selected by the digital tuner 11 is supplied sequentially to the digital demodulator 13 that, for example for a Japanese digital broadcast, employs Orthogonal Frequency Division Multiplexing (OFDM) and TS demodulator 15 where the reception signal is demodulated and decoded into digital video and audio signals. The reception signal selected by the analogue tuner 12 is supplied to the analogue demodulator 14 where the reception signal is demodulated into analogue video and audio signals.

The television set also includes a signal processor 16, a graphic processor 17, an On Screen Display (OSD) signal generator 18, a video processor 19, a display 20, an audio processor 21, a speaker 22, an operation panel 23, an infrared receiver 24, a remote controller 25, a flash memory 26, a Universal Serial Bus (USB) connector 27, a card connector 28 and a network communication circuit 29. The signal processor 16 selectively performs specific digital signal processing on the digital video and audio signals from the TS demodulator 15, and outputs the respective signals to the graphic processor 17 and audio processor 21. The signal processor 16 selectively digitalizes the analogue video and audio signals from the analogue demodulator 14, performs specific digital signal processing on these digitalized video and audio signals, and outputs these respective signals to the graphic processor 17 and the audio processor 21.

The graphic processor 17 selectively superimposes the OSD signal generated by the OSD signal generator 18 onto the digital video signal output from the signal processor 16. The video processor 19 matches the digital video signal output from the graphic processor 17 to the display 20, for example by performing transformations thereon such as size adjustment. The display 20 displays a video corresponding to the video signal output from the video processor 19. The audio processor 21 matches the digital audio signal output from the signal processor 16 to the speaker 22, for example by performing transformations thereon such as volume adjustment. The speaker 22 replays sound corresponding to the audio signal output from the audio processor 21.

The microprocessor 10 receives operation data from the operation panel 23, and operation data transmitted from the remote controller 25 and received by the infrared receiver 24, and controls each component in accordance with the operational content. The operation panel or keyboard 23 and the remote controller 25 correspond to an operational module that functions as a user interface. As shown in FIG. 11, the microprocessor 10 includes: a Central Processor Unit (CPU) 31 that performs various processing and control; Read Only Memory (ROM) 32 storing a control program for the CPU 31 and various initialization data; Random Access Memory (RAM) 33 that provides a work area of the CPU 31 for temporarily storing input and output data; an interface 34 that inputs and outputs setting data and control data for each of the components, such as through a I²C bus; and a clock circuit 35 that is corrected to conform to time data and date data received through a broadcast or network.

The USB connector 27 is provided for connecting various USB devices. The card connector 28 is provided for connected various media cards. The network communication circuit 29 is connected to the Internet either directly or via a Local Area Network (LAN). When time data is received from a broadcast, the time data is imported from the signal received by the antenna 1 into the microprocessor 10. When basic data such as time data is received from a network, the basic data is imported via the network communication circuit 29 into the microprocessor 10.

The USB connector 27 and the card connector 28 can read out video, photographic and music data from connected external USB devices (such as memory) and media cards.

The microprocessor 10 is configured so as to enable import videos held as files on a USB memory connected to the USB connector 27, or on a media card connected to the card connector 28, and enable control of display of each video on the display 20 through processing in the signal processor 16, the graphic processor 17, and the video processor 19.

With reference to FIG. 1, while a module corresponding to a hard disk H has been omitted, configuration may be provided with a storage medium as the USB device. For video or audio during viewing, substitution may be made with a replaying of recorded content thereof.

An EPG data receiving module 104, a system controller 110, a category determination module 112 for viewing contents, a real-time term explanation receiving processor 113, a term explanation display script generator 116 and a video and term explanation combining controller 117 may, for example, be configured primarily by the CPU 31, ROM 32, and RAM 33 of the microprocessor 10.

Explanation follows, with reference to FIG. 1, regarding the basic configuration of a content processing apparatus of the present exemplary embodiment in an example of application to a digital television.

A content processing apparatus 100 has an input means for inputting content data (such as compressed video data in MPEG format or compressed audio data). For example, a reception module 102 (corresponding to the digital tuner 11) receives broadcast content from an antenna 101 (corresponding to antenna 1), and demodulates the broadcast content with a digital demodulator 103 (corresponding to the digital demodulator 13 and the TS demodulator 15). However, instead of the content being broadcast content, the content may be received from a hard disk H or an optical disk in which contents has been pre-stored. The content data is decoded into video or audio data by an MPEG processor 106 (corresponding to the signal processor 16, the video processor 19 and the audio processor 21). Regarding output operation in the content processing apparatus 100, an output module 107 outputs video or audio data to a display 109 or speakers 108. The content processing apparatus 100 receives EPG data for each content with the EPG data receiving module 104. Regarding user operation, an operation module 111 receives the user operation. The system controller 110, such as a CPU, controls each of the configuration elements of the system.

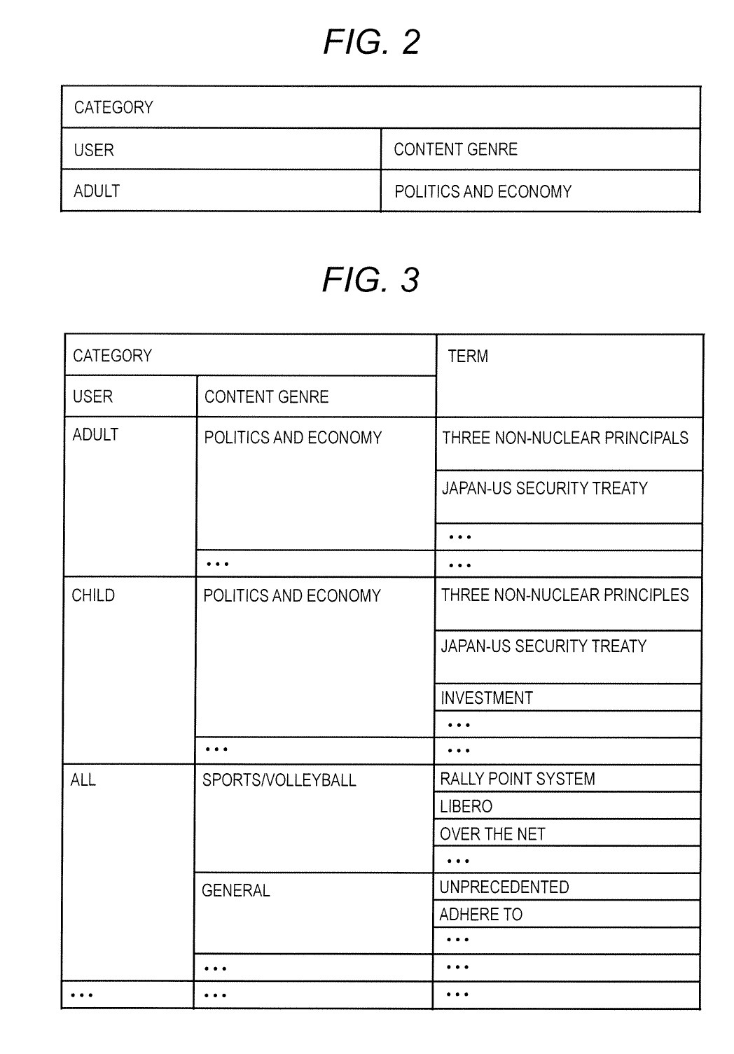

The content processing apparatus 100 of the exemplary embodiment has, in addition to the above standard configuration elements, configuration elements for receiving term explanation in real-time. First, prior to viewing the content, determination is made of the category for viewing content (referred to below as category) by the viewing content category determination module 112. The category means, for example data such as the data shown in FIG. 2. The category in the exemplary embodiment includes user data received from the operation module 111 by user operation, such as “adult”, “child”. The category also includes genre data received by the EPG data receiving module 104, such as “politics and economy” and “sports/volleyball”. When starting to view the content, the real-time term explanation receiving processor 113 employs the above video and/or audio data together with the above category to receive term explanations such that the term explanation can be displayed at the same time as viewing the content.

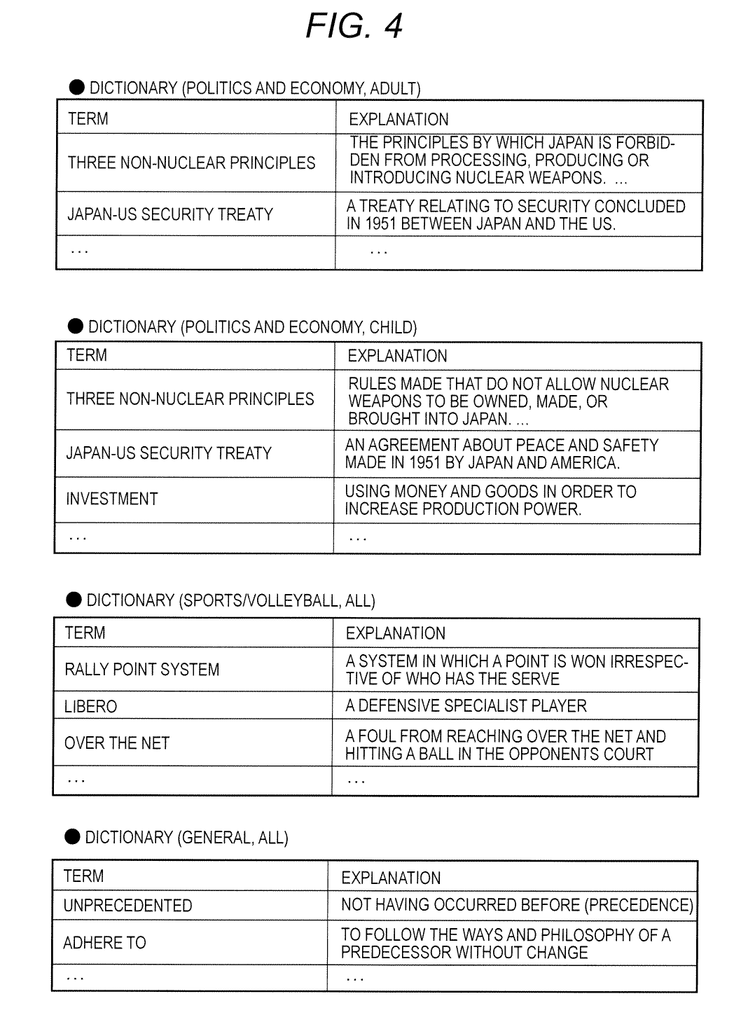

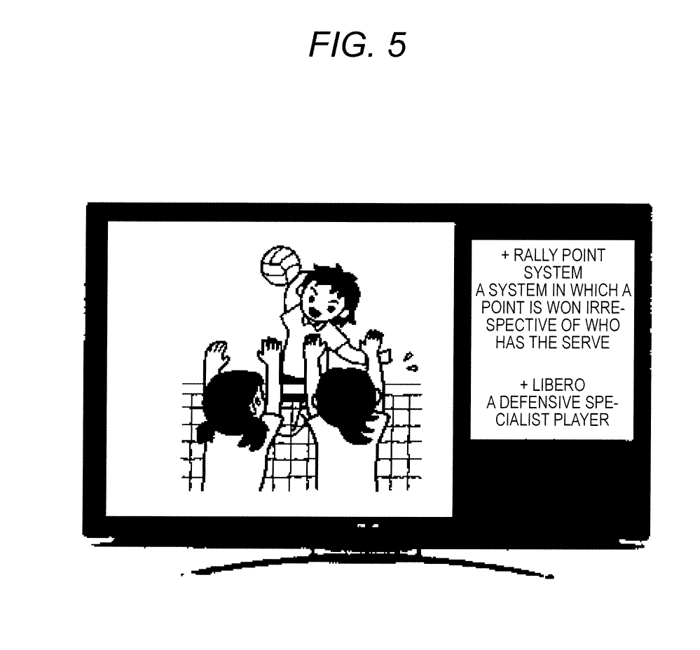

Explanation now follows regarding elements of the configuration of the real-time term explanation receiving processor 113. A term extraction module 1130 extracts terms from video or audio data. A category filter 1131 employs a category database 114 and determines in real-time whether or not there is a term extracted for the topic of the category data. The category database is, as shown in FIG. 3, a table listing terms by category. When a relevant term exists, the category filter 1131 selects the relevant term as a display candidate, and a term explanation receiving module 1132 receives term explanation from a dictionary database 115. The dictionary database 115 holds term explanations by category, for example as shown in FIG. 4. The received term explanation is stored in a display candidate term storage module 1133 together with the term itself. Note that the terms of FIG. 3 and the term explanations of FIG. 4 may be pre-imported into the apparatus during manufacture. Configuration may also so be made such that by operation of the apparatus, the terms and term explanations may be expanded on (including modification and deletion) after input using means such as the Web.

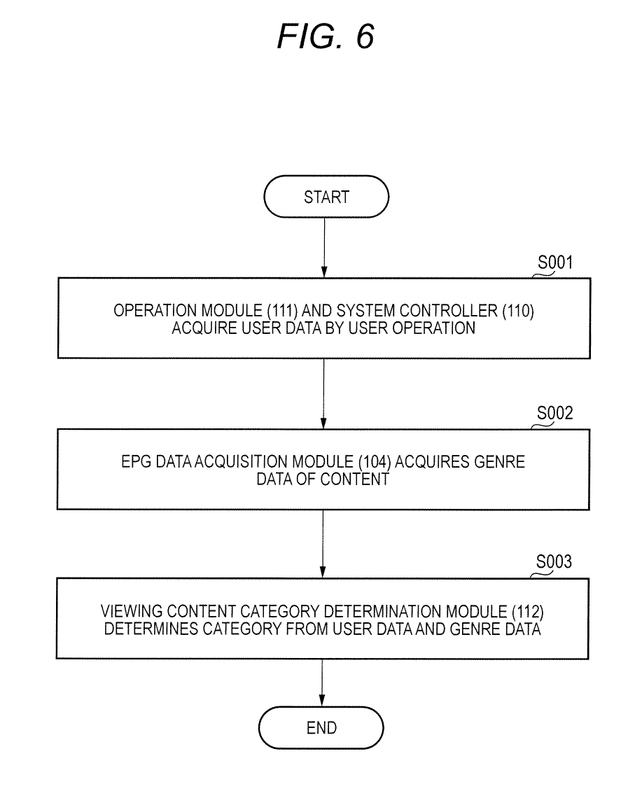

Explanation now follows regarding configuration elements of a display function for term explanations stored in the display candidate term storage module 1133. The term explanation display script generator 116 generates term explanation display script, such as XML. The video and term explanation combining controller 117 then combines the video data and the term explanation display script, generates video data for display use, and the output module 107 displays the video data for display use on the display 109. An example of a display of video data is shown in FIG. 5. FIG. 5 shows as two terms “rally point system” and “libero”. Corresponding term explanations are displayed of, respectively, “a system in which a point is won irrespective of who has the serve” and “defensive specialist player”.

Explanation now follows regarding processing flow in the exemplary embodiment.

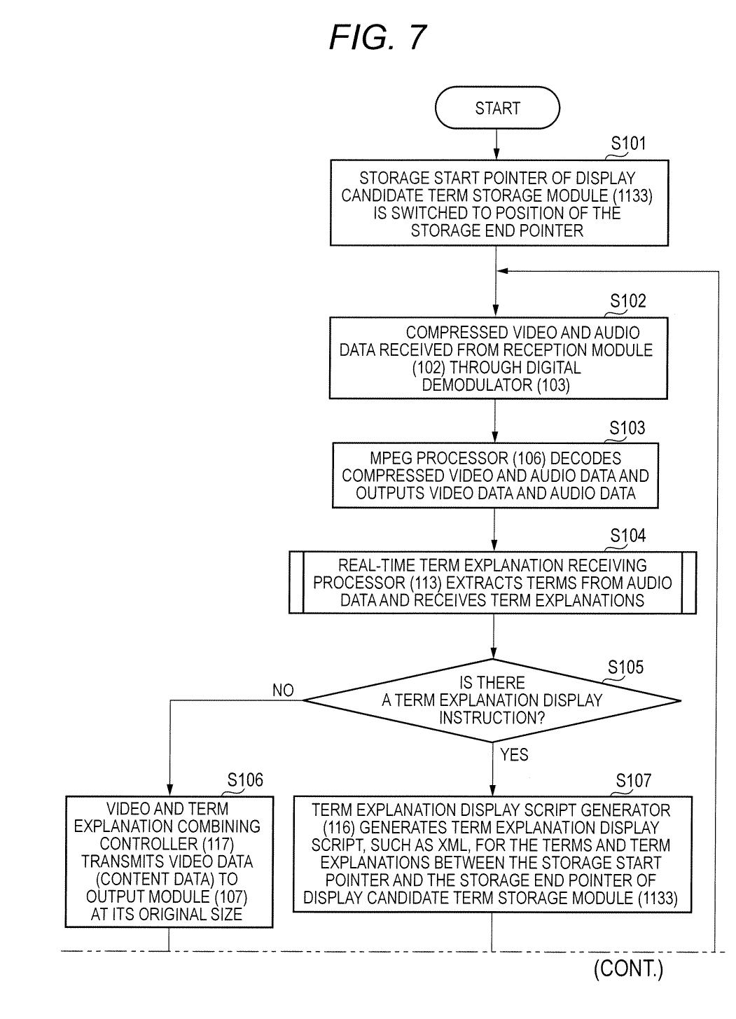

First, FIG. 6 shows a category determination flow at start of viewing. The category of viewing content, as shown in FIG. 2, is determined in the previous processing.

At step S001, the operation module 111 and the system controller 110 receive user data, such as “adult” or “child” by user operation.

At step S002, the EPG data receiving module 104 receives genre data of the content, such as “sports and economy” and “sports/volleyball”.

At step S003, the viewing content category determination module 112 determines the category from the user data received at step S001 and the genre data received at step S002.

Note that step S001 and step S002 are in no particular order, and while it is preferable to execute these steps prior to initiating viewing or during content selection, these steps may be executed any time prior to term explanation display instruction.

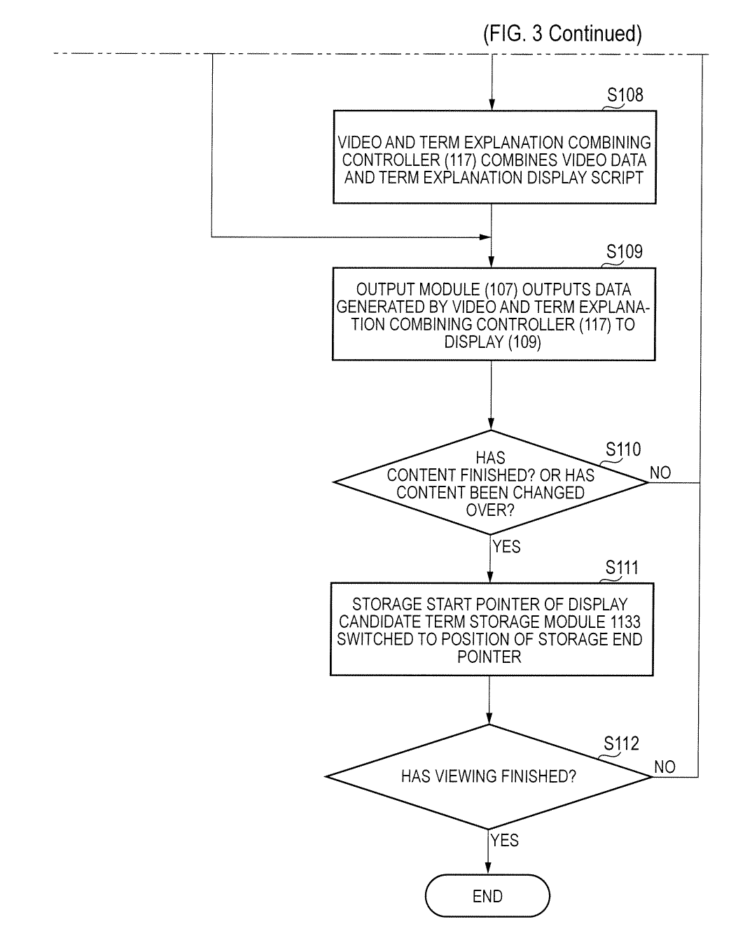

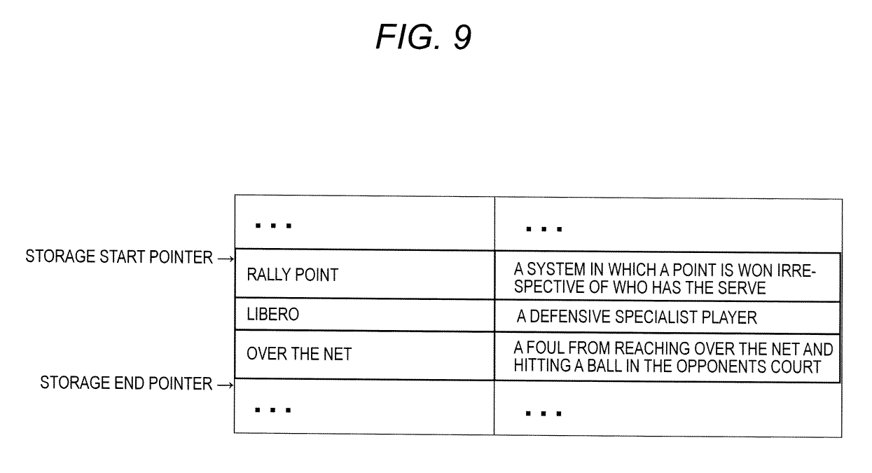

FIG. 7 shows a processing flow during viewing for displaying a term explanation in real-time. The display candidate term storage module 1133, as schematically shown in FIG. 9, may be configured utilizing a ring buffer, managing a storage start pointer indicating the position of commencing storing of display candidate terms and a storage end pointer indicating the final position of storage.

At step S101, the storage start pointer of the display candidate term storage module 1133 is switched to the position of the storage end pointer and the display candidate term storage module 1133 is initialized.

At step S102, compressed video and audio data is received from the reception module 102 through the digital demodulator 103.

At step S103, the MPEG processor 106 decodes the compressed video and audio data received at step S102 and outputs video data and audio data.

At step S104, the real-time term explanation receiving processor 113 extracts terms from the audio data and receives term explanations. Details regarding such processing are described later.

At step S105, processing proceeds to step S106 when there is no term explanation display instruction by user operation processing, and processing proceeds to step S107 when there is a term explanation display instruction (Yes at step S105).

At step S106, when there is no term explanation display instruction (No at step S105), the video and term explanation combining controller 117 transmits the video data (content data) to the output module 107 at its original size.

At step S107, when there is a term explanation display instruction (Yes at step S105), the term explanation display script generator 116 generates term explanation display script, such as XML, for the terms and term explanations from the storage start pointer to the storage end pointer of the display candidate term storage module 1133 ascertained at step S104. When there is a large number of display candidates, terms in a range from the storage end pointer back a given number of terms may be included as subject to display. After term explanation display script generation, processing may be performed to progress the storage start pointer to the storage end pointer position.

At step S108, the video and term explanation combining controller 117 combines the video data and the term explanation display script generated at step S105.

At step S109, the output module 107 outputs data generated at step S106 or step S108 to the display 109.

At step S110, if the content have not finished and the content have not been changed over (No at step S110), processing returns to step S102. If the content have finished or been changed over (Yes at step S110), processing proceeds to step S111.

At step S111, the storage start pointer of the display candidate term storage module 1133 is switched to the position of the storage end pointer, and the display candidate term storage module 1133 is initialized.

At step S112, if viewing has finished (No at step S112), processing is ended. If viewing has not yet finished (Yes at step S112), processing returns to step S102.

The processing of step S102 to step S110 is executed in the processing units of the content, such as by frame processing. Step S104 may be executed across plural frames of processing.

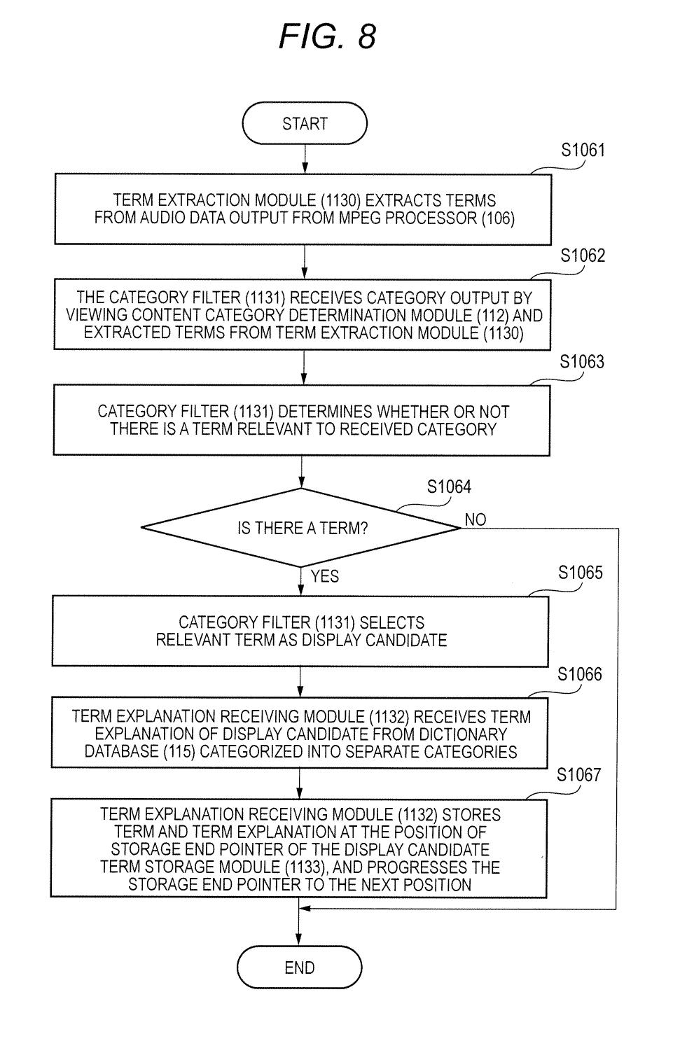

FIG. 8 shows a processing flow for the real-time term explanation receiving processor 113 receiving term explanations at step S104.

At step S1061, the term extraction module 1130 extracts terms from the audio data the MPEG processor 106 output at step S003. The term extraction module 1130 may use character recognition to extract text, such as subtitles, incorporated in videos, or may utilize text data of a data broadcast.

At step S1062, the category filter 1131 receives the category determined by the viewing content category determination module 112 at step S103 and the terms extracted at step S1061.

At step S1063, the category filter 1131 determines whether or not there is a relevant term from the category database 114 for the category received at step S1062.

At step S1064, when the result determined at step S1063 is that there is a relevant term (Yes at step S1064), processing proceeds to step S1065. When no relevant term is present (No at step S1064), processing is ended.

At step S1065, the category filter 1131 selects the relevant term as a display candidate.

At step S1066, the term explanation receiving module 1132 receives term explanation of the display candidate from the dictionary database 115 that is categorized into separate categories.

At step S1067, the term explanation receiving module 1132 stores the term and term explanation received at step S1066 at the position of the storage end pointer of the display candidate term storage module 1133, and progresses the storage end pointer to the next position.

### Modified Example 1

In the exemplary embodiment, the category database 114 and the dictionary database 115 may be not separate databases, but may be a single database. Namely, the content processing apparatus according to the exemplary embodiment may have groups of terms and term explanations held together by category topic.

### Modified Example 2

In the exemplary embodiment, the content processing apparatus may have a function for searching related terms. This improves usability such as for the purpose of education.

### Modified Example 3

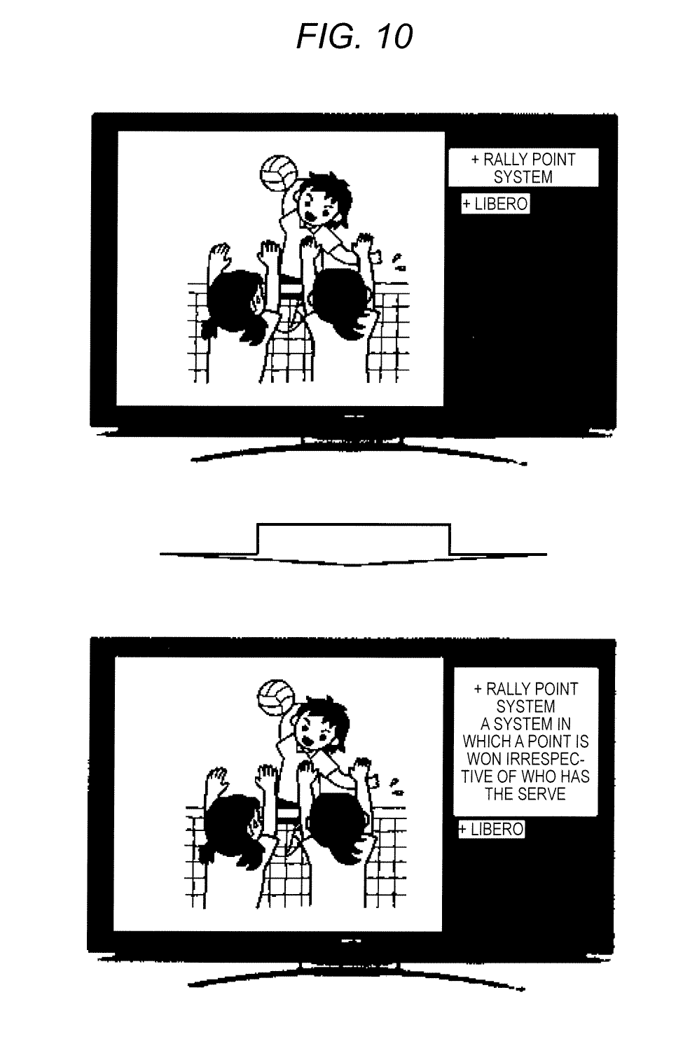

In the exemplary embodiment, as in the example shown in FIG. 10 (see FIG. 5), the content processing apparatus has a function that can select display of term explanations for each term. Such a function is readily realizable, such as by XML script.

A text-to-speech function may be also provided for reading out selected term explanations.

### Modified Embodiment 4

In the exemplary embodiment, a mechanism may be added for storing terms that have been reference once, content is prioritized for display according to individual user interest built up from history, and/or a term that has already been referenced is subjected to filtering. Also, a function may be added to re-display or stop filtering by pressing one or other button.

According to the real-time term explanation receiving processor of the exemplary embodiment, when investigation into the explanation of a term in the content being viewed is desired, the term explanation can be investigated with ease without interrupting viewing the content. Furthermore, since a large capacity buffer is not employed for the content, such a term explanation function is realizable at lower cost.

Furthermore, by applying categories and word attributes in each kind of database, a content processing apparatus can be provided with high usability even in developing countries of another ethnicity and many languages, such as India.

A wide effect for increasing language ability can also be expected.

### Summary of the Exemplary Embodiment

(1) In a content processing apparatus that inputs, for example, broadcast content and outputs to a display, the content processing apparatus is provided with: a real-time term explanation receiving processor that receives an explanation of a term included in the content being viewed at the same time as viewing; and a video and term explanation combining module that combines videos of the content with the term explanation, such that explanation of terms in viewing can be displayed in real-time.

(2) In the content processing apparatus of the above column (1), the content processing apparatus is provided with: a category determination module that determines a category (user data such as “age”, nationality” and “gender”, and EPG genre data of the content) for the content being viewed; and a category filter that filters terms by category when receiving term explanations, such that the receiving speed of the term explanations can be accelerated.

(3) In the content processing apparatus of the above column (2), the content processing apparatus is provided with: a category database configured with a list for searching the category for a term; and a dictionary database configured with groups of term explanations categorized by category.

(4) In the content processing apparatus of the above column (1), a display candidate term storage module that stores the received term explanation result, includes a storage medium for which a storage start pointer indicating the position at which storage of display candidate terms started and a storage end pointer that indicates the final position of storage are managed.

(5) In the content processing apparatus of the above column (1), the storage start pointer is initialized to the storage end pointer position when the viewing content has been changed over.

In the exemplary embodiment, video data of content and term explanations can be displayed at the same time by having the real-time term explanation receiving processor. Moreover, since display is made in real-time, there is no requirement to accumulate and buffer content until there is a user request.

In the exemplary embodiment, due to the real-time term explanation receiving processor filtering by category, the time till term explanation can be shortened, and a greater real-time ability can be secured.

The following effects are accordingly obtained. When investigation is into explanation of a term in the content being viewed is desired, the term explanation can be investigated with ease without interrupting viewing. Furthermore, since a large capacity buffer is not employed for the content, such a term explanation function is realizable at lower cost.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content processing apparatus comprising:
an output module configured to output a content in a viewable format;
a real-time term explanation receiving processor configured to receive an explanation of a term included in the content being output; and
a video and term explanation combining module configured to combine a video of the content with the term explanation,
wherein the term explanation corresponding to the video is displayed in real-time on the output module.

2. The apparatus of claim 1 further comprising:
a category determination module configured to determine a category corresponding to the content; and
a category filter configured to filter the term by the category when receiving the term explanation,
wherein the category filter is configured to accelerate a receiving speed of the term explanation.

3. The apparatus of claim 2 further comprising:
a category database configured with a list for searching the category for the term;
wherein the category filter is configured to act by referencing the category database.

4. The apparatus of claim 2 further comprising:
a dictionary database configured with groups of term explanations categorized by each category,
wherein the real-time term explanation receiving processor is configured to act by referencing the dictionary database.

5. The apparatus of claim 2, wherein the real-time term explanation receiving processor is configured to store a history of the term which has been referenced, and to prioritize a display of a suitable category for a user's interest according to the history.

6. The apparatus of claim 2, wherein the real-time term explanation receiving processor is configured to store a history of the term which has been referenced, and to subject the referenced term to filtering.

7. The apparatus of claim 2, wherein the real-time term explanation receiving processor is configured to re-display the term explanations or block filtering of the term explanations, based on external operation.

8. The apparatus of claim 1 further comprising:
a display candidate term storage module configured to store the received term explanation result,
wherein the display candidate term storage module includes a storage medium for which a storage start pointer indicating the position at which storage of display candidate terms started and a storage end pointer that indicates the final position of storage are managed.

9. The apparatus of claim 8, wherein the storage start pointer is configured to be initialized to the final position of storage at least when the content has changed.

10. A content processing method for a content processing apparatus having an output module configured to output a content in a viewable format, the content processing method comprising:
receiving an explanation of a term included in the content;
combining a video of the content with the term explanation; and
displaying in real-time the term explanation for the video on the output module.
